(19) United States
(12) Patent Application Publication
(10) Pub. No.: US 2026/0177682 A1
(43) Pub. Date: Jun. 25, 2026

(54) OBJECT DETECTION APPARATUS, OBJECT DETECTION METHOD, AND NON-TRANSITORY RECORDING MEDIUM

(71) Applicant: Panasonic Automotive Systems Co., Ltd., Kanagawa (JP)

(72) Inventors: Tadashi MORITA, Kanagawa (JP); Yuichi ISHIKAWA, Hyogo (JP); Shuji AKAMATSU, Kanagawa (JP)

(73) Assignee: Panasonic Automotive Systems Co., Ltd., Kanagawa (JP)

(21) Appl. No.: 19/429,668

(22) Filed: Dec. 22, 2025

(30) Foreign Application Priority Data
Dec. 24, 2024 (JP) 2024-227954

(51) Int. Cl. G01S 7/539; G01S 15/931

(52) U.S. Cl. CPC G01S 7/539; G01S 15/931

(57) ABSTRACT

An object detection apparatus of the present disclosure includes a signal analyzing circuitry which, in operation, derives, based on a reflected wave resulting from an ultrasonic wave of a plurality of frequencies reflected by an object, frequency characteristics indicating a relationship between an amplitude and a frequency of the reflected wave; and an identifying circuitry which, in operation, performs identification on whether a reflecting surface of the object is a flat surface or a curved surface, based on the frequency characteristics in a predetermined frequency range.

### Technical Field

The present disclosure relates to an object detection apparatus an object detection method, and a non-transitory recording medium, each detecting an object, using ultrasonic waves.

### Background Art

An object detection apparatus has been known, which transmits ultrasonic waves, receives a reflected wave reflected by an object, and detects the object based on the reflected wave.

### Citation List

### Patent Literature

PTL1

Japanese Patent Application Laid-Open No. 2008-058059

### Summary of Invention

### Solution to Problem

An object detection apparatus according to one aspect of the present disclosure includes: a signal analyzing circuitry which, in operation, derives, based on a reflected wave resulting from an ultrasonic wave of a plurality of frequencies reflected by an object, frequency characteristics indicating a relationship between an amplitude and a frequency of the reflected wave; and an identifying circuitry which, in operation, performs identification on whether a reflecting surface of the object is a flat surface or a curved surface, based on the frequency characteristics in a predetermined frequency range.

An object detection method according to one aspect of the present disclosure, includes, performed by a computer: deriving, based on a reflected wave resulting from an ultrasonic wave of a plurality of frequencies reflected by an object, frequency characteristics indicating a relationship between an amplitude and a frequency of the reflected wave; and identifying whether a reflecting surface of the object is a flat surface or a curved surface, based on the frequency characteristics in a predetermined frequency range.

A non-transitory recording medium according to one aspect of the present disclosure stores therein a program causing a computer to execute processing including: deriving, based on a reflected wave resulting from an ultrasonic wave of a plurality of frequencies reflected by an object, frequency characteristics indicating a relationship between an amplitude and a frequency of the reflected wave; and identifying whether a reflecting surface of the object is a flat surface or a curved surface, based on the frequency characteristics in a predetermined frequency range.

### Advantageous Effects of Invention

According to the present disclosure, a shape of a detected object can be identified based on a reflected wave.

### Brief Description of Drawings

FIG. 1 is a block diagram for describing a functional configuration of an object detection apparatus;

FIG. 2A is a schematic diagram for describing a simulation conducted to generate reference data;

FIG. 2B is a schematic diagram for describing a simulation conducted to generate reference data;

FIG. 2C is a schematic diagram for describing a simulation conducted to generate reference data;

FIG. 3A is a diagram for describing reference data (distance 1 m) generated by a simulation;

FIG. 3B is a diagram for describing reference data (distance 1 m) generated by a simulation;

FIG. 3C is a diagram for describing reference data (distance 1 m) generated a simulation;

FIG. 4A is a diagram for describing reference data (distance 2 m) generated by the simulation;

FIG. 4B is a diagram for describing reference data (distance 2 m) generated by the simulation;

FIG. 4C is a diagram for describing reference data (distance 2 m) generated by the simulation;

FIG. 5A is a diagram for describing reference data (distance 3 m) generated by the simulation;

FIG. 5B is a diagram for describing reference data (distance 3 m) generated by the simulation;

FIG. 5C is a diagram for describing reference data (distance 3 m) generated by the simulation;

FIG. 6 is a flowchart for describing an operation example of an identifier during first identification processing;

FIG. 7 is a flowchart for describing an operation example of the identifier during second identification processing;

FIG. 8A is a diagram for describing a method in which the identifier performs detailed determination on whether an object is a curbstone;

FIG. 8B is a diagram for describing the method in which the identifier performs detailed determination on whether the object is a curbstone;

FIG. 8C is a diagram for describing the method in which the identifier performs detailed determination on whether the object is a curbstone;

FIG. 9 is a flowchart for describing an operation example of the object detection apparatus; and

FIG. 10 is a diagram illustrating a hardware configuration of a computer.

### Description of Embodiments

Hereinafter, each embodiment of the present disclosure will be described in detail with reference to the drawings. However, unnecessary detailed description, for example, a detailed description of well-known matters or a redundant description of substantially the same configurations may be omitted.

### Configuration

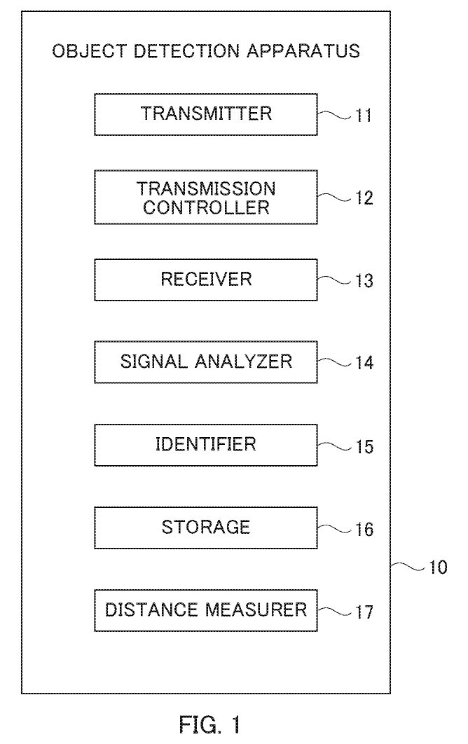

A configuration of object detection apparatus 10 according to an embodiment of the present disclosure will be described. FIG. 1 is a block diagram for describing a functional configuration of object detection apparatus 10. As illustrated in FIG. 1, object detection apparatus 10 includes transmitter 11, transmission controller 12, receiver 13, signal analyzer 14, identifier 15, storage 16, and distance measurer 17.

Object detection apparatus 10 is mounted on, for example, a vehicle. In this case, the functional configuration of object detection apparatus 10 excluding transmitter 11 and receiver 13 is implemented by a computer mounted on the vehicle executing a predetermined program. Examples of the computer mounted on the vehicle include an Electronic Control Unit (ECU) for controlling the vehicle. However, the computer that implements the functional configuration of object detection apparatus 10 is not limited to the ECU and may be, for example, a microcomputer independent of the ECU, a Personal Computer (PC), a tablet terminal, or the like. Further, in a case where the computer that implements the functional configuration of object detection apparatus 10 is communicably connected to transmitter 11 and receiver 13 via radio communication or the like, the computer may not be mounted on the vehicle.

An object detection apparatus according to the present disclosure need not be mounted on the vehicle.

Transmitter 11 transmits ultrasonic waves of a plurality of frequencies under the control of transmission controller 12. Transmitter 11 is, for example, a speaker that transmits ultrasonic waves corresponding to a voltage of a control signal from transmission controller 12.

For example, transmitter 11 transmits a chirp wave in which a frequency is changed over time under the control of transmission controller 12.

Alternatively, for example, transmitter 11 may transmit ultrasonic waves of a plurality of frequencies at the same time by including a plurality of vibration bodies driven at frequencies different from one another.

Transmission controller 12 controls transmitter 11 to transmit ultrasonic waves of a plurality of frequencies.

Receiver 13 receives a reflected wave resulting from the ultrasonic waves that have been transmitted by transmitter 11 and then reflected by an object. As described above, since transmitter 11 transmits ultrasonic waves of a plurality of frequencies, the reflected wave received by receiver 13 is ultrasonic waves including a plurality of frequencies.

Receiver 13 is, for example, a microphone that receives the reflected wave and includes a reception element that generates a reception signal corresponding to an intensity of the received reflected wave. Receiver 13 outputs the generated reception signal to signal analyzer 14.

In a case where object detection apparatus 10 is mounted on the vehicle, the object is, for example, an obstacle that is present in a traveling direction of the vehicle and hinders traveling of the vehicle. Alternatively, the object is a non-obstacle that is present in the traveling direction of the vehicle but does not hinder the traveling of the vehicle. Examples of the types of object include a wall surface, a pole, and a curbstone. The wall surface is, for example, a wall surface of a parking lot or the like. The pole is, for example, a pole that defines a parking space. The curbstone is a vehicle stopper (also referred to as a wheel stopper, a parking block, or a tire stopper) that defines a position of a rear wheel during vehicle stoppage in a parking lot. Since the wall surface and the pole are objects to be prevented from coming into contact with a vehicle body, the wall surface and the pole correspond to the obstacle. It is assumed that the curbstone is an object that comes into contact with a wheel but has a low possibility of coming into contact with the vehicle body due to its height. Therefore, the curbstone corresponds to the non-obstacle.

In the following description, an example is assumed in which a wall surface, a pole, and a curbstone are set in advance as candidates for the types of object detected by object detection apparatus 10. However, the candidates for the types of object detected by the object detection apparatus according to the present disclosure are not limited to these examples, and other various obstacles or non-obstacles may be assumed.

Signal analyzer 14 derives frequency characteristics indicating a relationship between an amplitude (reception intensity) and a frequency of the reflected wave based on the reception signal output from receiver 13. Signal analyzer 14 derives frequency characteristics of an envelope of the reflected wave by performing envelope detection on the reflected wave. Signal analyzer 14 outputs data related to the derived frequency characteristics to identifier 15. In the following description, the data output by signal analyzer 14 may be referred to as actual measurement data.

Identifier 15 performs identification processing of an object based on the actual measurement data. The identification processing by identifier 15 includes first identification processing of identifying whether a reflecting surface of the object is a flat surface or a curved surface, and second identification processing of identifying the type of object. Details of the identification processing by identifier 15 will be described below.

Storage 16 stores reference data used by identifier 15 to perform identification of the object during the second identification processing. The reference data is data used to identify the type of object by identifier 15 via collation with the actual measurement data. The reference data is measured or calculated in advance by an experiment or a simulation to determine what characteristics the frequency characteristics based on the reflected wave by a specific type of object exhibit. The term "in advance" herein refers to a timing before design or shipment of object detection apparatus 10.

The reference data is generated by conducting an experiment or a simulation while changing the type of object. For example, when the reference data is generated by an experiment, the reference data is generated by signal analyzer 14 deriving the frequency characteristics based on the reception signal generated by receiver 13 that has actually transmitted the ultrasonic waves from transmitter 11 and received the reflected wave for each of the candidates (wall surface, pole, and curbstone) for the type of object set in advance. For example, when the reference data is generated by a simulation, the frequency characteristics derived based on the reflected wave that occurs when the ultrasonic waves are transmitted for each of the wall surface, the pole, and the curbstone are derived by the simulation.

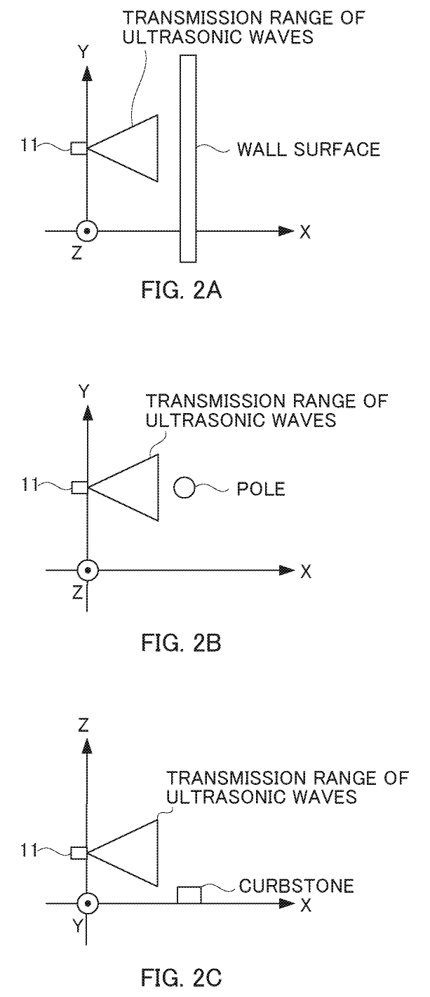

FIGS. 2A to 2C are schematic diagrams for describing a simulation conducted to generate reference data. FIG. 2A is a diagram for describing a simulation when the object is a wall surface having a sufficient width and height. FIG. 2B is a diagram for describing a simulation when the object is a pole having a diameter of 60 mm. FIG. 2C is a diagram for describing a simulation when the object is a curbstone having a height of 100 mm. In FIGS. 2A to 2C, a positional relationship between transmitter 11 and the object is illustrated, and illustration of receiver 13 is omitted.

FIG. 2A illustrates a state in which a wall surface sufficiently longer than a transmission range of ultrasonic waves (e.g., a detectable range of object detection apparatus 10) is present in a transmission direction of the ultrasonic waves. FIG. 2B illustrates a state in which a pole having a diameter of 60 mm is present in the transmission direction of the ultrasonic waves. FIGS. 2A and 2B illustrate a state in which transmitter 11 and the object are viewed from above. In the examples illustrated in FIGS. 2A and 2B, the heights of the wall surface and the pole are infinite.

FIG. 2C illustrates a state in which a curbstone having a height of 100 mm is present in the transmission direction of the ultrasonic waves. In the example illustrated in FIG. 2C, it is assumed that transmitter 11 (and receiver 13) is installed at a height (height of a rear bumper of an existing vehicle) of 390 mm from the ground. FIG. 2C illustrates a state in which transmitter 11 and the object are viewed from the side. In the examples illustrated in FIGS. 2A and 2B, a two-dimensional simulation is performed in a flat surface (in the drawing, an XY plane) parallel to the ground. In the example illustrated in FIG. 2C, a two-dimensional simulation is performed in a flat surface (in the drawing, an XZ plane) perpendicular to the ground.

The frequency characteristics derived from the reflected wave from the object change depending on a distance from transmitter 11 and receiver 13 to the object (hereinafter, simply referred to as a distance). Therefore, the reference data may be generated for each predetermined distance. In the following description, it is assumed that the reference data is generated in each case of a distance of 1 m, a distance of 2 m, and a distance of 3 m.

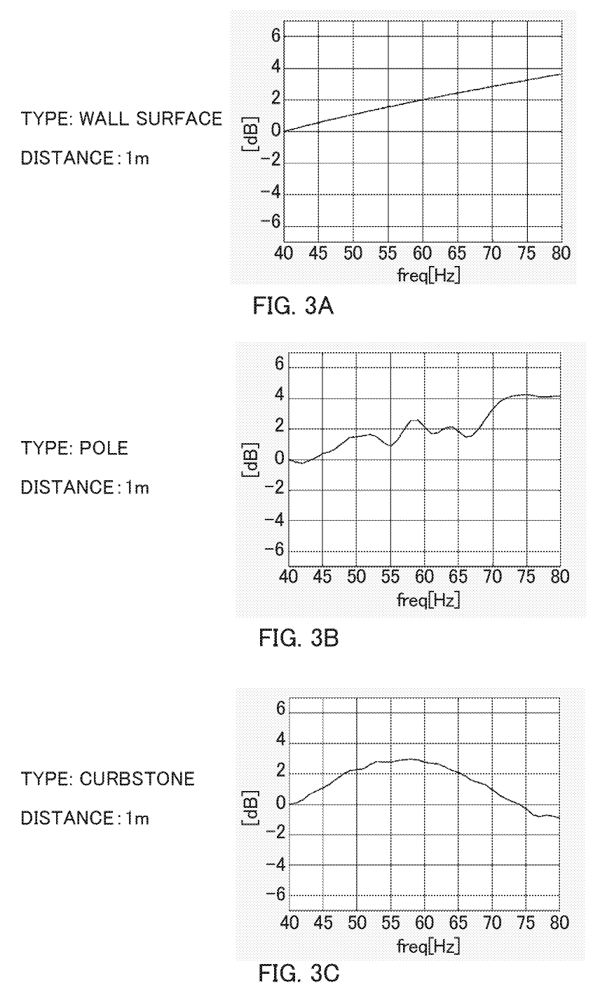

FIGS. 3A to 3C, FIGS. 4A to 4C, and FIGS. 5A to 5C are diagrams for describing the reference data generated via the simulations of FIGS. 2A to 2C. In FIGS. 3A to 3C, FIGS. 4A to 4C, and FIGS. 5A to 5C, the frequency characteristics of the reflected wave are illustrated in a graph in which the amplitude (reception intensity) of the reflected wave is taken as a vertical axis and the frequency is taken as a horizontal axis. In FIGS. 3A to 3C, FIGS. 4A to 4C, and FIGS. 5A to 5C, the reception intensity of the vertical axis is indicated in a range of approximately -7 dB to approximately 7 dB. In FIGS. 3A to 3C, FIGS. 4A to 4C, and FIGS. 5A to 5C, the frequency of the horizontal axis is indicated in a range of approximately 40 kHz to approximately 80 kHz.

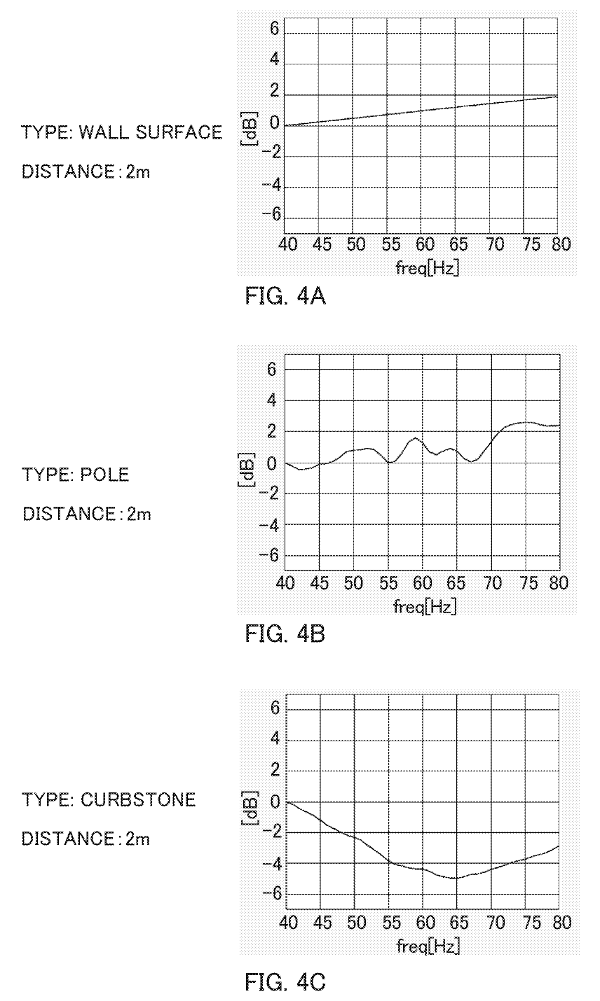

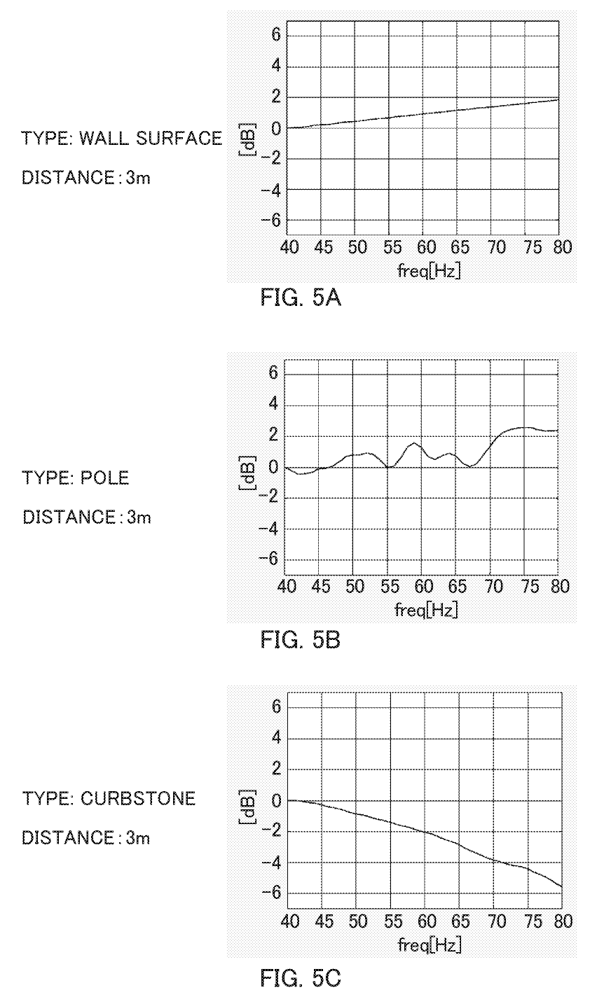

FIGS. 3A to 3C illustrate the reference data with a distance of 1 m. FIGS. 4A to 4C illustrate the reference data with a distance of 2 m. FIGS. 5A to 5C illustrate the reference data with a distance of 3 m.

FIGS. 3A, 4A and 5A illustrate the reference data when the object is a wall surface. FIGS. 3B, 4B and 5B illustrate the reference data when the object is a pole having a diameter of 60 mm. FIGS. 3C, 4C and 5C show the reference data when the object is a curbstone having a height of 100 mm.

As illustrated in FIGS. 3A to 3C, FIGS. 4A to 4C, and FIGS. 5A to 5C, the shape of the graph indicating the frequency characteristics obtained via a simulation varies depending on the type of object and the distance. For example, when the object is a wall surface, the shape of the graph indicating the frequency characteristics is a monotonically increasing linear shape regardless of the distance. For example, when the object is a pole, the shape of the graph indicating the frequency characteristics is a curve shape having a plurality of extreme points regardless of the distance. For example, when the object is a curbstone, the shape of the graph indicating the frequency characteristics greatly changes depending on the distance and is a convex upward curve shape (distance 1 m), a convex downward (or concave) curve shape (distance 2 m), or a gently monotonically decreasing curve shape (distance 3 m).

As described above, the shape of the graph indicating the frequency characteristics derived from the reflected wave from the object greatly varies depending on the type of object. The reason for this is considered that the shape of the reflecting surface of the object that reflects the ultrasonic waves and the area of the reflecting surface vary. For example, when the object is a pole, the reflecting surface is a curved surface, and the area of the reflecting surface that substantially reflects the ultrasonic waves in the transmission direction is significantly smaller than that when the object is a wall surface. For example, when the object is a curbstone, the reflecting surface is a flat surface, but the area of the reflecting surface is smaller than that when the object is a wall surface and larger than that when the object is a pole. The difference in the reference data obtained by the simulation for each object illustrated in FIGS. 3A to 3C, FIGS. 4A to 4C, and FIGS. 5A to 5C is considered to be caused by the difference in the shape and the area of the reflecting surface.

When the object is a curbstone, the shape of the graph indicating the frequency characteristics varies depending on the distance supposedly due to the positional relationship between transmitter 11 and the curbstone. As described above, in the simulation (see FIG. 2C) related to the curbstone, it is assumed that the height of the curbstone is 100 mm and transmitter 11 is installed at 390 mm above the ground. An angle formed by the straight line connecting transmitter 11 and the reflecting surface (vertical surface close to transmitter 11) of the curbstone changes depending on the distance between transmitter 11 and the curbstone. As a result, the degree of reflection of the ultrasonic waves by the reflecting surface of the curbstone changes, so that the shape of the graph indicating the frequency characteristics is considered to change depending on the distance.

Storage 16 may store the reference data as data indicating the shape of the graph of the frequency characteristics as illustrated in FIGS. 3A to 3C, FIGS. 4A to 4C, and FIGS. 5A to 5C, or may store the reference data as data in a table format indicating the frequency characteristics. In a case where storage 16 stores the reference data in a table format, data indicating the shape of the graph of the frequency characteristics as illustrated in FIGS. 3A to 3C, FIGS. 4A to 4C, and FIGS. 5A to 5C based on the reference data in the table format may be generated when identifier 15 reads out the reference data.

The shape of the graph of the frequency characteristics in the present disclosure includes at least the number of extreme points of the graph of the frequency characteristics in a predetermined frequency range or the inclination of the graph of the frequency characteristics in a predetermined frequency range.

The description of FIG. 1 will be resumed. Distance measurer 17 measures a distance. Distance measurer 17 measures the distance by, for example, transmitting a laser or a millimeter wave and measuring a time of flight until the laser or the millimeter wave is reflected by the object and returns.

### Details of Identification Processing

Hereinafter, the identification processing of an object by identifier 15 will be described in detail.

As described above, identifier 15 includes: first identification processing of identifying whether the object is a flat surface or a curved surface based on the actual measurement data of the frequency characteristics output by signal analyzer 14; and second identification processing of identifying which of candidates for the type of object set in advance is the type of object via collation of the actual measurement data with the reference data stored in storage 16. In the present embodiment, the candidates for the type of object in the second identification processing are a wall surface, a pole, and a curbstone.

### First Identification Processing

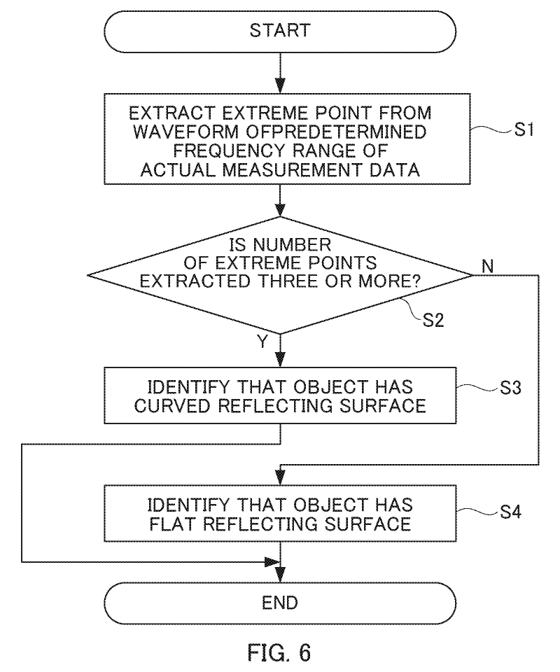

FIG. 6 is a flowchart for describing an operation example of identifier 15 during the first identification processing.

In step S1, identifier 15 extracts an extreme point from a graph of a predetermined frequency range of actual measurement data. The predetermined frequency range is a range that is optionally set in a range of frequencies that transmitter 11 can transmit. In the flowchart illustrated in FIG. 6, an assumption is made that the predetermined frequency range is set to a range of f1 or more and f2 or less. The values of f1 and f2 are not limited in the present disclosure, but in order to perform identification processing with high accuracy, the predetermined frequency range may be set to somewhat a wide range. For example, the values of f1 and f2 may be set to 40 kHz ≤ f1 ≤ 55 kHz and 70 kHz ≤ f2 ≤ 80 kHz in consideration of the graphs of the reference data indicated in FIGS. 3A to 3C, FIGS. 4A to 4C, and FIGS. 5A to 5C.

In step S2, identifier 15 determines whether the number of extreme points extracted in step S1 is three or more. When it is determined that the number of extreme points is three or more (step S2: Y), identifier 15 proceeds to step S3, and when it is determined that the number of extreme points is not three or more (step S2: N), identifier 15 proceeds to step S4. The number of extreme points is not limited to three, and can be set to any number (first predetermined number) in consideration of the measurement environment.

In step S3, identifier 15 identifies that the object that reflects the reflected wave indicating the frequency characteristics of the actual measurement data is an object having a curved reflecting surface.

In step S4, identifier 15 identifies that the object that reflects the reflected wave indicating the frequency characteristics of the actual measurement data is an object having a flat reflecting surface.

After step S3 or step S4, identifier 15 ends the first identification processing.

The basis for the identification in the first identification processing described above is as follows. As indicated in the reference data (simulation data) of FIGS. 3A to 3C, FIGS. 4A to 4C, and FIGS. 5A to 5C, it is known that, for the pole having a curved surface as the reflecting surface, the graph of the frequency characteristics of the reflected wave has a curve shape including a large number of extreme points in a frequency range of 40 kHz to 80 kHz. Further, as indicated in the reference data of FIGS. 3A to 3C, FIGS. 4A to 4C, and FIGS. 5A to 5C, it is known that, for the wall surface or the curbstone having a flat reflecting surface, the graph of the frequency characteristics of the reflected wave has a curve shape including zero or one extreme point in a frequency range of 40 kHz to 80 kHz. Therefore, when the graph of the frequency characteristics of the actual measurement data includes three or more extreme points, identifier 15 can identify that the object that reflects the reflected wave indicating the frequency characteristics of the actual measurement data is an object including a curved reflecting surface, and when the graph of the frequency characteristics of the actual measurement data does not include three or more extreme points, identifier 15 can identify that the object that reflects the reflected wave indicating the frequency characteristics of the actual measurement data is an object including a flat reflecting surface.

As described above, with the first identification processing, it is possible to appropriately identify whether the object that reflects the reflected wave indicating the frequency characteristics of the actual measurement data has a flat reflecting surface or a curved reflecting surface.

### Second Identification Process

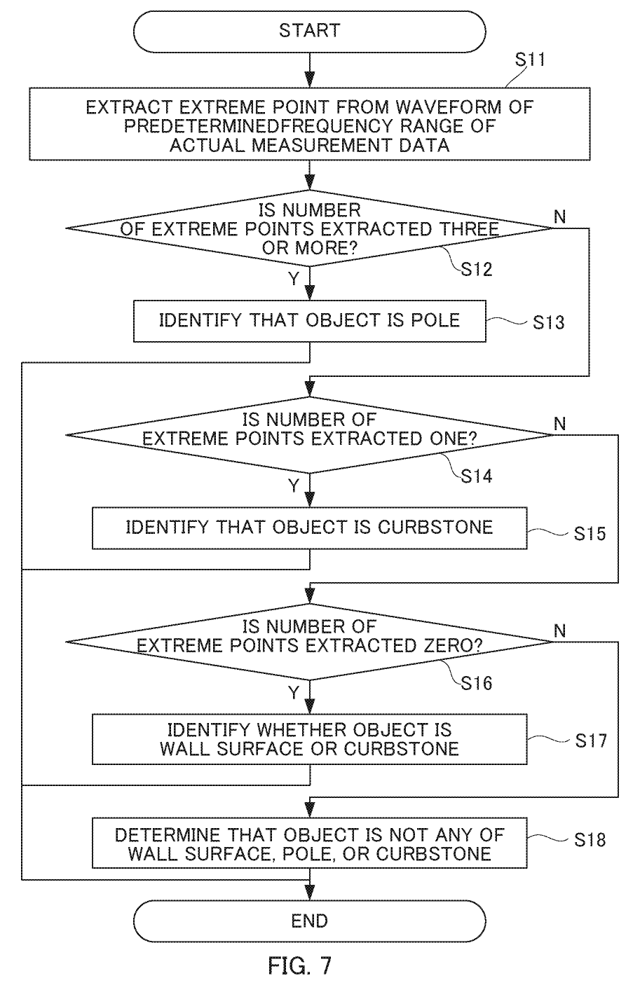

FIG. 7 is a flowchart for describing an operation example of identifier 15 during the second identification processing. The second identification processing identifies, from among candidates for type of object that are set in advance, which type is the object that reflects the reflected wave indicating the frequency characteristics of the actual measurement data.

In step S11, identifier 15 extracts an extreme point from a graph of a predetermined frequency range of the actual measurement data. Step S11 in the second identification processing is the same processing as step S1 in the first identification processing.

In step S12, identifier 15 determines whether the number of extreme points extracted in step S11 is three or more. When determining that the number of extreme points is three or more (step S12: Y), identifier 15 proceeds to step S13, and when determining that the number of extreme points is not three or more (step S12: N), identifier 15 proceeds to step S14. Step S12 in the second identification processing is the same processing as step S2 in the first identification processing.

In step S13, identifier 15 identifies that the object that reflects the reflected wave indicating the frequency characteristics of the actual measurement data is a pole having a curved reflecting surface. After step S13, identifier 15 ends the second identification processing.

In step S14, identifier 15 determines whether the number of extreme points extracted in step S11 is one. When determining that the number of extreme points is one (step S14: Y), identifier 15 proceeds to step S15, and when determining that the number of extreme points is not one (step S14: N), identifier 15 proceeds to step S16. The number of extreme points in step S14 is not limited to one, and can be set to a second predetermined number that is smaller than the first predetermined number and larger than zero in consideration of the measurement environment.

In step S15, identifier 15 determines whether the object is a curbstone by collating the reference data (see FIGS. 3C, 4C and 5C) related to the curbstone with the actual measurement data.

In the example of the reference data indicated in FIGS. 3A to 3C, FIGS. 4A to 4C, and FIGS. 5A to 5C, the graph of the frequency characteristics in which there is one extreme point in a predetermined frequency range is generated by a curbstone in a case of the distance of 1 m or 2 m as illustrated in FIGS. 3C and 4C. When the number of extreme points in the predetermined frequency range is one in the frequency characteristics of the actual measurement data, identifier 15 can determine that the object is likely to be a curbstone.

As will be described below, identifier 15 may more accurately identify whether the object is a curbstone by performing more detailed collation between the actual measurement data and the reference data.

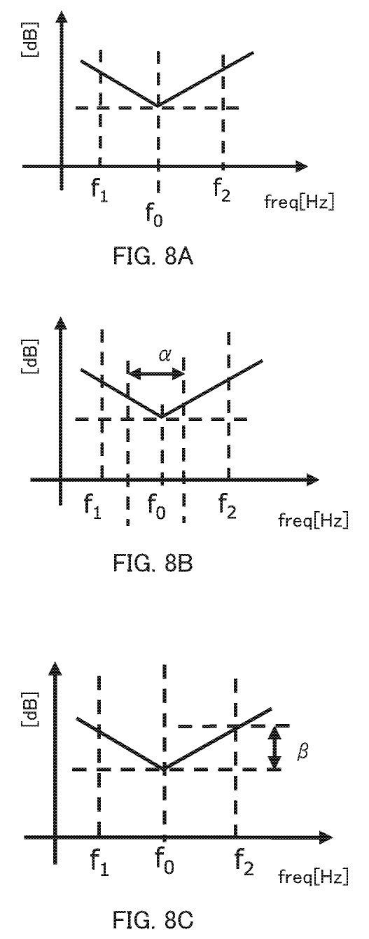

FIGS. 8A to 8C are diagrams for describing a method in which identifier 15 determines in detail whether the object is a curbstone. The vertical axis of FIGS. 8A to 8C is an amplitude (reception intensity) of the ultrasonic waves, and the horizontal axis is a frequency. In the example illustrated in FIGS. 8A to 8C, it is assumed that the graph of the frequency characteristics of the actual measurement data has a convex downward (concave) curve shape as illustrated in FIG. 8A. First, identifier 15 determines whether the graph of the reference data related to the curbstone in a case of the distance of 2 m has the same shape from among the reference data stored in storage 16.

For example, as illustrated in FIG. 8B, identifier 15 determines whether frequency f0 at the extreme point of the actual measurement data is a value included in a range of frequency f0' ± α at the extreme point of the reference data. α is a predetermined margin, and is, for example, α = 5 kHz. When frequency f0 at the extreme point of the actual measurement data is a value included in the range of frequency f0' ± α at the extreme point of the reference data, identifier 15 determines that the object is a curbstone. When frequency f0 at the extreme point of the actual measurement data is not included in the range of frequency f0' ± α at the extreme point of the reference data, identifier 15 determines, for example, that the object that reflects the reflected wave indicating the frequency characteristics of the actual measurement data is not a curbstone.

Alternatively, as illustrated in FIG. 8C, identifier 15 calculates difference da between amplitude a0 at the extreme point and amplitude a2 at frequency f2 in the actual measurement data and calculates difference da' between amplitude a0' at the extreme point and amplitude a2' at maximum frequency f2 in a predetermined range in the reference data. Identifier 15 determines whether difference da of the actual measurement data is a value included in a range of difference da' ± β of the reference data. β is a predetermined margin, and is, for example, β = 1 dB. When difference da of the actual measurement data is included in difference da' ± β of the reference data, identifier 15 determines that the object is a curbstone. When difference da of the actual measurement data is not included in range of difference da' ± β of the reference data, identifier 15 determines, for example, that the object that reflects the reflected wave indicating the frequency characteristics of the actual measurement data is not a curbstone.

In the example illustrated in FIG. 8C, the a description has been given with the example in which identifier 15 takes the difference between the amplitude value of the extreme point and the amplitude value at maximum frequency f2 in the predetermined range, but in the present disclosure, for example, the difference between the amplitude value of the extreme point and the amplitude value at minimum frequency f1 in a predetermined range may be calculated in each of the actual measurement data and the reference data to perform the identification.

The description of FIG. 7 will be resumed. In step S16, identifier 15 determines whether the number of extreme points extracted in step S11 is zero. When determining that the number of extreme points is zero (step S16: Y), identifier 15 proceeds to step S17, and when determining that the number of extreme points is not zero (step S16: N), identifier 15 proceeds to step S18.

In step S17, identifier 15 determines whether the object is a wall surface or a curbstone by collating the reference data related to the wall surface (see FIGS. 3A, 4A and 5A), the reference data related to the curbstone (see FIGS. 3C, 4C and 5C), and the actual measurement data.

In the example of the reference data illustrated in FIGS. 3A to 3C, FIGS. 4A to 4C, and FIGS. 5A to 5C, the graph of the frequency characteristics in which the number of extreme points is zero in a predetermined frequency range is generated in a case of a wall surface in which the distance is 1 m, 2 m, or 3 m and in a case of a curbstone in which the distance is 3 m as illustrated in FIGS. 3A, 4A, 5A and 5C. Here, as illustrated in FIGS. 3A, 4A and 5A, the graph of the reference data related to a wall surface has a monotonically increasing shape. Meanwhile, as illustrated in FIG. 5C, the graph of the reference data related to a curbstone in a case of the distance of 3 m has a monotonically decreasing shape. Therefore, when the inclination is a positive value in the frequency characteristics of the actual measurement data, identifier 15 identifies that the object is a wall surface, and when the inclination is a negative value, identifier 15 identifies that the object is a curbstone.

In step S18, identifier 15 determines that the object that reflects the reflected wave indicating the frequency characteristics of the actual measurement data is none of the candidates (neither wall surface, pole, nor curbstone) for the type of the object. This is because, in the example of the reference data illustrated in FIGS. 3A to 3C, FIGS. 4A to 4C, and FIGS. 5A to 5C, there is no data indicating the graph of the frequency characteristics in which the number of extreme points is less than three and is neither one nor zero in the predetermined frequency range.

As described above, with the second identification processing, it is possible to identify the type of object via collation of the actual measurement data of the reflected wave from the object with the reference data prepared in advance for each type of object.

In the operation example of the second identification processing illustrated in FIG. 7, identifier 15 performs the identification by collating the reference data stored in storage 16 with the actual measurement data and extracting the reference data having the same shape as the shape of the graph of the actual measurement data. For example, identifier 15 may perform the identification by extracting the reference data corresponding to the distance to the object measured separately by distance measurer 17 in advance and collating the reference data with the actual measurement data. In this case, the number of pieces of reference data with which identifier 15 performs collation can be reduced, thus making it possible to perform the second identification processing faster.

The operation example of the second identification processing illustrated in FIG. 7 is premised on the reference data having the shapes of the graphs of the frequency characteristics illustrated in FIGS. 3A to 3C, FIGS. 4A to 4C, and FIGS. 5A to 5C. In the object detection apparatus according to the present disclosure, in practice, a determination criterion for each determination in the second identification processing by the identifier can be appropriately adjusted based on the shape of the graph of the frequency characteristics indicated in the reference data. For example, something other than a wall surface, a pole, and a curbstone is included as a candidate for the type of object, the identifier may perform new determination based on the shape of the graph of the frequency characteristics in the reference data of the object.

### Operation Example of Object Detection Apparatus 10

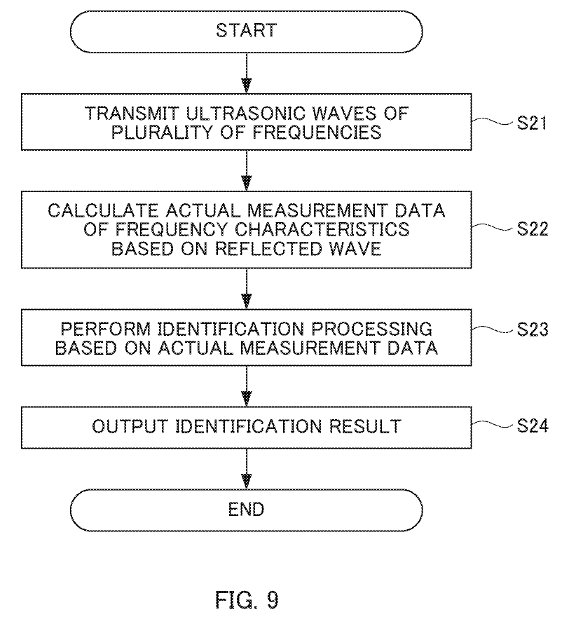

Hereinafter, an operation example of an entirety of object detection apparatus 10 will be described. FIG. 9 is a flowchart for describing the operation example of object detection apparatus 10.

In step S21, transmitter 11 transmits ultrasonic waves of a plurality of frequencies.

In step S22, signal analyzer 14 derives the actual measurement data of the frequency characteristics based on the reception signal generated by receiver 13 from the reflected wave of the object.

In step S23, identifier 15 performs the identification processing based on the actual measurement data (see FIGS. 6 or 7).

In step S24, identifier 15 outputs the identification result.

For example, when object detection apparatus 10 is used for collision prevention in automatic parking control of a vehicle, object detection apparatus 10 outputs a detection result indicating that an object is detected and an identification result to a computer that performs the automatic parking control of the vehicle. For example, when the identification result of the object is a curbstone, the possibility that the object comes into contact with the vehicle body is low, so that the computer that performs the automatic parking control can move the vehicle until the wheel approaches the curbstone (vehicle stopper) without stopping the vehicle at that point. For example, when the identification result of the object is a wall surface, the contact between the wall surface and the vehicle body is avoided, so that the computer that performs the automatic parking control can stop the vehicle. For example, when the identification result of the object is a pole that defines the parking space, the computer that performs the automatic parking control can decelerate the vehicle to gradually locate a vehicle body near the pole while avoiding the contact between the pole and the vehicle body.

### Example of Hardware Configuration of Computer

Object detection apparatus 10 described in the above-described embodiment is a computer, and the functional configuration thereof is implemented by the computer executing a predetermined program. Hereinafter, an example of a hardware configuration of the computer that implements each function of object detection apparatus 10 will be described.

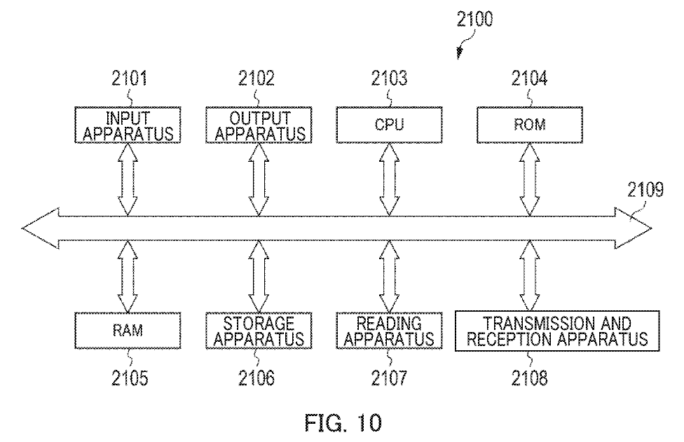

FIG. 10 is a diagram illustrating a hardware configuration of computer 2100. As illustrated in FIG. 10, computer 2100 includes input apparatus 2101, such as an input button and a touchpad, output apparatus 2102, such as a display and a speaker, central processing unit (CPU) 2103, read only memory (ROM) 2104, and random access memory (RAM) 2105. In addition, computer 2100 includes storage apparatus 2106 such as a hard disk apparatus and a solid state drive (SSD), reading apparatus 2107 that reads information from a recording medium such as a digital versatile disk read only memory (DVD-ROM) and a universal serial bus (USB) memory, and a transmission and reception apparatus 2108 that communicates via a network. The above-described units are connected to each other by bus 2109.

Reading apparatus 2107 reads a program for realizing the functions of the above-described units from the recording medium on which the program is recorded, and stores the program in storage apparatus 2106. Alternatively, the transmission and reception apparatus 2108 communicates with a server apparatus connected to the network, and stores the program for realizing the functions of the above-described units, which is downloaded from the server apparatus, in storage apparatus 2106.

CPU 2103 copies the program stored in storage apparatus 2106 to RAM 2105 and sequentially reads out and executes the commands included in the program from RAM 2105 to realize the functions of the above-described units. In addition, in execution of the program, the information obtained in the various processes described in each embodiment is stored in RAM 2105 or storage apparatus 2106 and is appropriately used.

In the description above, the term ending with a suffix, such as “-er” “-or” or “-ar” may be interchangeably replaced with another term, such as “circuit (circuitry),” “device,” “unit,” or “module.” Further, apparatuses may adopt a configuration to be implemented by a CPU using a program accumulated in storage.

The present application claims the benefit and priority of Japanese Patent Application No. 2024-227954 filed on December 24, 2024, the entire disclosure of which, including the specification, drawings, and abstracts, is incorporated herein by reference.

### INDUSTRIAL APPLICABILITY

The present disclosure is useful for an object detection apparatus that detects an object, using ultrasonic waves.

1. An object detection apparatus, comprising:
a signal analyzing circuitry which, in operation, derives, based on a reflected wave resulting from an ultrasonic wave of a plurality of frequencies reflected by an object, frequency characteristics indicating a relationship between an amplitude and a frequency of the reflected wave; and
an identifying circuitry which, in operation, performs identification on whether a reflecting surface of the object is a flat surface or a curved surface, based on the frequency characteristics in a predetermined frequency range.

2. The object detection apparatus according to claim 1, wherein, the identifying circuitry which, in operation, performs the identification based on a number of extreme points of a graph of the frequency characteristics in the predetermined frequency range.

3. The object detection apparatus according to claim 2, wherein,
the identifying circuitry which, in operation, identifies that the reflecting surface is a flat surface in a case that the number of extreme points is less than a first predetermined number, and
the identifying circuitry which, in operation, identifies that the reflecting surface is a curved surface in a case that the number of extreme points is equal to or more than the first predetermined number.

4. The object detection apparatus according to claim 1, wherein, the identifying circuitry which, in operation, identifies a type of the object from among candidates for the type of the object set in advance, based on a shape of a graph of the frequency characteristics in the predetermined frequency range.

5. The object detection apparatus according to claim 4, wherein, the identifying circuitry which, in operation, identifies that the object is a curbstone in a case that the number of extreme points of the graph in the predetermined frequency range is one.

6. The object detection apparatus according to claim 5, wherein, the identifying circuitry which, in operation, identifies that the object is a wall surface or a curbstone in a case that the number of extreme points is zero.

7. The object detection apparatus according to claim 6, wherein, the identifying circuitry which, in operation, identifies whether the object is a wall surface or a curbstone, based on an inclination of the graph in a case that the number of extreme points is zero.

8. The object detection apparatus according to claim 7, wherein,
the identifying circuitry which, in operation, identifies that the object is a wall surface in a case that the graph monotonically increases, and
the identifying circuitry which, in operation, identifies that the object is a curbstone in a case that the graph monotonically decreases.

9. The object detection apparatus according to claim 6, further comprising: a storage which, in operation, stores reference data of the frequency characteristics generated in advance for each type of the object, wherein,
the identifying circuitry which, in operation, identifies whether the object is a wall surface or a curbstone by collating the reference data with the shape of the graph.

10. The object detection apparatus according to claim 9, further comprising: a distance measurer which, in operation, measures a distance to the object, wherein,
the storage which, in operation, stores the reference data generated in advance for each of distances different from one another, and
the identifying circuitry which, in operation, identifies whether the object is a wall surface or a curbstone by collating the reference data corresponding to the measured distance with the graph.

11. The object detection apparatus according to claim 1, wherein, the ultrasonic wave of the plurality of frequencies is a chirp wave in which a frequency changes with time.

12. The object detection apparatus according to claim 11, wherein the signal analyzing circuitry which, in operation, derives the frequency characteristics by performing envelope detection on the reflected wave.

13. An object detection method, comprising, performed by a computer:
deriving, based on a reflected wave resulting from an ultrasonic wave of a plurality of frequencies reflected by an object, frequency characteristics indicating a relationship between an amplitude and a frequency of the reflected wave; and
identifying whether a reflecting surface of the object is a flat surface or a curved surface, based on the frequency characteristics in a predetermined frequency range.

14. The object detection method according to claim 13, wherein, the identifying is performed based on a number of extreme points of a graph of the frequency characteristics in the predetermined frequency range.

15. The object detection method according to claim 14, wherein,
the reflecting surface is identified as a flat surface in a case that the number of extreme points is less than a first predetermined number, and
the reflecting surface is identified as a curved surface in a case that the number of extreme points is equal to or more than the first predetermined number.

16. The object detection method according to claim 13, wherein, the computer identifies a type of the object from among candidates for the type of the object set in advance, based on a shape of a graph of the frequency characteristics in the predetermined frequency range.

17. The object detection method according to claim 16, wherein, the computer identifies that the object is a curbstone in a case that a number of extreme points of the graph in the predetermined frequency range is one.

18. The object detection method according to claim 17, wherein, the computer identifies that the object is either a wall surface or a curbstone in a case that the number of extreme points is zero.

19. The object detection method according to claim 18, wherein, the computer identifies whether the object is a wall surface or a curbstone, based on an inclination of the graph in a case that the number of extreme points is zero.

20. A non-transitory recording medium storing therein a program causing a computer to execute processing comprising:
deriving, based on a reflected wave resulting from an ultrasonic wave of a plurality of frequencies reflected by an object, frequency characteristics indicating a relationship between an amplitude and a frequency of the reflected wave; and
identifying whether a reflecting surface of the object is a flat surface or a curved surface, based on the frequency characteristics in a predetermined frequency range.
